(19) United States
(12) Patent Application Publication
(10) Pub. No.: US 2026/0034856 A1
(43) Pub. Date: Feb. 5, 2026

(54) COOLANT CIRCULATION SYSTEM

(71) Applicant: Mazda Motor Corporation, Hiroshima (JP)

(72) Inventors: Shigeru Kobayashi, Aki-gun (JP); Yuma Miyauchi, Aki-gun (JP)

(21) Appl. No.: 19/263,754

(22) Filed: Jul. 9, 2025

(30) Foreign Application Priority Data
Jul. 31, 2024 (JP) 2024-124224

(51) Int. Cl. B60H 1/00

(52) U.S. Cl. CPC B60H 1/00899

(57) ABSTRACT

A coolant circulation system that circulates a CO₂ coolant to cool a motor in a vehicle includes a controller that performs a control such that an input coolant having an input pressure and being in a gas phase is outputted from upstream-side expansion valves, and the pressure of the input coolant is reduced by a downstream-side expansion valve into an output coolant having an output pressure. The controller estimates a corresponding pressure of the coolant at a corresponding point on a saturated vapor line located on a low pressure side of a local maximum pressure, a specific enthalpy at the corresponding point being equal to a specific enthalpy of the input coolant, sets the corresponding pressure to a target output pressure, and controls the downstream-side expansion valve such that its output pressure reaches the target output pressure.

### TECHNICAL FIELD

The present disclosure relates to a coolant circulation system, and particularly relates to a coolant circulation system for cooling a motor of a vehicle.

### BACKGROUND ART

Conventionally, a coolant circulation system that utilizes a refrigeration cycle has been used in a vehicle (see Japanese Patent Laid-Open No. 2022-186209, for example). The coolant circulation system described in Japanese Patent Laid-Open No. 2022-186209 is used for an on-vehicle air conditioning apparatus, and a condenser, an expansion valve, an evaporator, and a compressor are provided in a circulation channel in this order.

In general, in a coolant circulation system, although a gas-liquid mixed phase coolant is supplied to an evaporator, in order to prevent a return of a liquid phase coolant to a compressor, it is necessary to supply vaporized coolant, being superheated vapor, to the compressor. Therefore, the gas-liquid mixed phase coolant completely changes to a gas phase coolant in the evaporator.

In the system of Japanese Patent Laid-Open No. 2022-186209, a compressor is an electric compressor including an inverter, an electric motor, and a compression part, and a coolant that flows into the electric compressor from the evaporator absorbs heat from the inverter and the electric motor and, thereafter, flows into the compression part. Accordingly, in the system of Japanese Patent Laid-Open No. 2022-186209, when the electric compressor has a large power consumption, there is a risk of the coolant that flows into the compression part having an excessively high superheat degree.

For this reason, in the system of Japanese Patent Laid-Open No. 2022-186209, when the electric compressor has a large power consumption, by adjusting the flow rate of the coolant or the valve opening with the expansion valve, the coolant is not completely gasified by the evaporator, and the coolant in a gas-liquid mixed phase is supplied to the inverter and the electric motor of the electric compressor, and the coolant is completely gasified by the inverter and the electric motor. Consequently, in this system, it is possible to prevent a situation in which the coolant that flows into the compression part has an excessively high superheat degree.

As described above, in the system of Japanese Patent Laid-Open No. 2022-186209, in addition to the ordinary evaporator, the inverter and the electric motor also serve as evaporators, and the coolant in a gas-liquid mixed phase can be supplied to these evaporators.

### SUMMARY

### Technical Problem

On the other hand, the inventors of the present disclosure have attempted to develop a new coolant circulation system in a vehicle, such as an electric vehicle, the new coolant circulation system including, as an evaporator, a relatively large-sized motor used to drive the vehicle or the like, in addition to an ordinary evaporator (for example, a heat exchanger or the like of an on-vehicle air conditioning apparatus). This new system is configured such that coolant is caused to directly flow into the motor (that is, including a space between a rotor and a stator).

In this case, since the coolant in a liquid phase has a relatively high viscosity, when the coolant in a liquid phase flows into the motor, a problem occurs in which stirring resistance is generated between the rotor and the stator during the rotation of the motor. The stirring resistance increases quadratically with respect to the rotational speed and hence, particularly in an ultra-high speed motor, a high stirring resistance is generated. Accordingly, the inventors of the present disclosure have found a technical problem in which, in a coolant circulation system in which the inside of the motor is directly cooled with coolant, it is necessary to ensure that the coolant is gasified, that is, a gas phase coolant, or a coolant that is in a gas-liquid mixed state, but has a low proportion of liquid phase, and mainly has a gas phase, flows into the motor.

The inventors of the present disclosure also found a technical problem in which, to ensure that a coolant that is gasified due to an increase in specific enthalpy still has sufficient cooling capability, it is necessary to maintain the superheat degree of the gasified coolant at a low value. It is noted that the term “superheat” refers to a state in which coolant has a temperature elevated above the saturation temperature in the process where the coolant absorbs heat at a given pressure, thus being shifted from a gas-liquid mixed phase to a gas phase, and the term “superheat degree” refers to the extent to which the temperature is elevated from the saturation temperature.

The present disclosure has been made to solve the above-described technical problems, and it is an object of the present disclosure to provide a coolant circulation system that provides, to the motor, a gas phase coolant in which a superheat degree is suppressed to a low value.

### Solution to Problem

To achieve the above-mentioned object, a coolant circulation system of the present disclosure is directed to a coolant circulation system that circulates a CO₂ coolant to cool a motor in a vehicle, the coolant circulation system including: a coolant circulation circuit that forms a refrigeration cycle including, in a channel through which the coolant is circulated, a compressor, a first heat exchanger, an upstream-side expansion valve, a second heat exchanger, a downstream-side expansion valve, and the motor; the compressor compressing the coolant; the first heat exchanger causing the coolant, which is compressed, to radiate heat; the upstream-side expansion valve causing the coolant, which is caused to radiate heat, to expand; the second heat exchanger causing the coolant, which is expanded by the upstream-side expansion valve, to absorb heat; the downstream-side expansion valve causing the coolant that flows out from the second heat exchanger to expand; and the motor causing the coolant, which is expanded by the downstream-side expansion valve, to absorb heat; first sensors that detect at least a pressure and a temperature of an input coolant, the input coolant being the coolant to be supplied to the downstream-side expansion valve; a second sensor that detects at least a pressure of an output coolant, the output coolant being the coolant discharged from the downstream-side expansion valve; and a controller that performs a control such that the input coolant having an input pressure and being in a gas phase is outputted from the upstream-side expansion valve, the pressure of the input coolant is reduced by the downstream-side expansion valve, and the output coolant having an output pressure is outputted from the downstream-side expansion valve. The input pressure is set to a pressure higher than a local maximum pressure at a local maximum point, at which a specific enthalpy reaches a local maximum, on a saturated vapor line of a pressure-enthalpy chart of the coolant, and the controller estimates a corresponding pressure of the coolant at a corresponding point on the saturated vapor line, a specific enthalpy at the corresponding point being equal to a specific enthalpy of the input coolant, the corresponding point being located on a low pressure side of the local maximum pressure, sets the corresponding pressure to a target output pressure, and controls the downstream-side expansion valve based on a detection signal from the second sensor such that the output pressure of the downstream-side expansion valve reaches the target output pressure.

In the present disclosure having such a configuration, the motor is incorporated in the refrigeration cycle as a heat source that elevates the specific enthalpy of the coolant, in addition to the second heat exchanger. That is, the present disclosure has a configuration in which although a gas-liquid mixed phase coolant is supplied to the second heat exchanger in the same manner as the ordinary refrigeration cycle, the coolant that absorbs heat from the second heat exchanger further cools the motor. At this point of operation, in the present disclosure, the corresponding pressure of the coolant at the corresponding point on the saturated vapor line is estimated, a specific enthalpy at the corresponding point being equal to the specific enthalpy of the coolant that absorbs heat from the second heat exchanger, thus being in a gas phase (input coolant), the corresponding point being located on the low pressure side of the local maximum pressure, and this corresponding pressure is set to the target output pressure for the downstream-side expansion valve. Consequently, in the present disclosure, it is possible to supply the output coolant in a gas phase from the downstream-side expansion valve to the motor, the output coolant having sufficient cooling capability with a superheat degree of zero.

In the present disclosure, it is preferable that, based on detection signals from the first sensors, the controller control a flow rate in the upstream-side expansion valve such that the specific enthalpy of the input coolant is lower than the specific enthalpy at the local maximum point. According to the present disclosure having such a configuration, it is possible to supply the input coolant with a low superheat degree to the downstream-side expansion valve.

In the present disclosure, it is preferable that the controller set the target output pressure to a predetermined set pressure when the controller determines, based on detection signals from the first sensors, that the specific enthalpy of the input coolant is greater than or equal to the specific enthalpy at the local maximum point. According to the present disclosure having such a configuration, when the superheat degree of the input coolant is high, so that the corresponding point is not present, by setting the target output pressure to the predetermined set pressure (for example, the lower limit pressure), cooling capability of the output coolant can be ensured.

In the present disclosure, it is preferable that the controller set the target output pressure to a predetermined lower limit pressure instead of the corresponding pressure when the specific enthalpy at the corresponding point is less than a predetermined lower limit specific enthalpy; and the lower limit pressure is a pressure higher than a sublimation pressure in a wet vapor region of the pressure-enthalpy chart, the sublimation pressure being a pressure at which dry ice can be present. According to the present disclosure having such a configuration, when the corresponding point is present and there is a risk of the coolant at the corresponding point sublimating into dry ice, by setting the target output pressure to the predetermined lower limit pressure, it is possible to prevent the output coolant from containing a coolant in a solid phase.

In the present disclosure, it is preferable that the coolant circulation circuit further include a gas-liquid separator in the channel at a position between the downstream-side expansion valve and the motor, and the coolant from which liquid is separated by the gas-liquid separator is supplied to the motor. According to the present disclosure having such a configuration, when the output coolant is in a gas-liquid mixed phase (for example, when the target output pressure is not at the corresponding pressure, but is at the lower limit pressure), by recovering the liquid from the output coolant by the gas-liquid separator, it is possible to supply only a coolant in a gas phase to the motor.

In the present disclosure, it is preferable that a coolant passage be formed in the motor in such a manner as to supply the coolant to a space between a stator and a rotor of the motor. According to the present disclosure having such a configuration, a gas phase coolant is supplied to the space in the motor and hence, it is possible to suppress an increase in stirring resistance when the motor is in operation.

In the present disclosure, it is preferable that the second heat exchanger include a heat exchanger of an on-vehicle air conditioning apparatus and/or a heat exchanger for a vehicle battery. According to the present disclosure having such a configuration, it is possible to incorporate the ordinary heat exchanger for the vehicle in the coolant circulation system.

### Advantageous Effects

With the coolant circulation system according to the present disclosure, it is possible to provide, to the motor, a gas phase coolant in which a superheat degree is suppressed to a low value.

### BRIEF DESCRIPTION OF DRAWINGS

FIG. 1 is a schematic configuration diagram of a coolant circulation system according to an embodiment of the present disclosure.

FIG. 2 is an electrical block diagram of the coolant circulation system according to the embodiment of the present disclosure.

FIG. 3A is a perspective view of a motor of the coolant circulation system according to the embodiment of the present disclosure.

FIG. 3B is a transverse cross-sectional view of the motor of the coolant circulation system according to the embodiment of the present disclosure.

FIG. 3C is a longitudinal cross-sectional view of the motor of the coolant circulation system according to the embodiment of the present disclosure.

FIG. 4 is an explanatory diagram of a refrigeration cycle in the coolant circulation system according to the embodiment of the present disclosure.

FIG. 5 is an explanatory diagram of a refrigeration cycle in the coolant circulation system according to the embodiment of the present disclosure in a steady state.

FIG. 6A is an explanatory diagram of a refrigeration cycle in the coolant circulation system according to the embodiment of the present disclosure.

FIG. 6B is an explanatory diagram of a refrigeration cycle in the coolant circulation system according to the embodiment of the present disclosure.

FIG. 6C is an explanatory diagram of a refrigeration cycle in the coolant circulation system according to the embodiment of the present disclosure.

FIG. 7 is a process flow of the coolant circulation system according to the embodiment of the present disclosure.

### DETAILED DESCRIPTION

Hereinafter, a motor system according to an embodiment of the present disclosure will be described with reference to attached drawings.

### Configuration of System

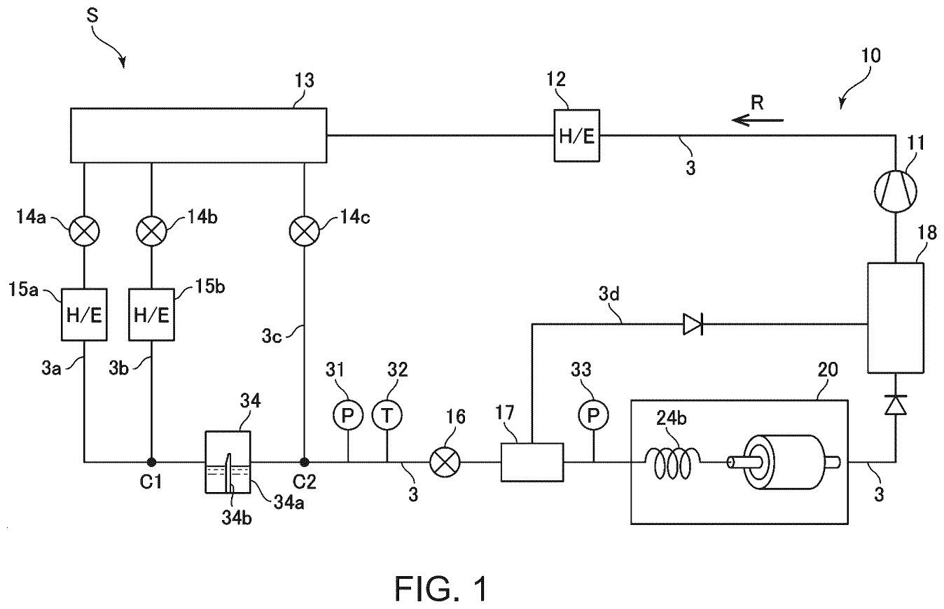

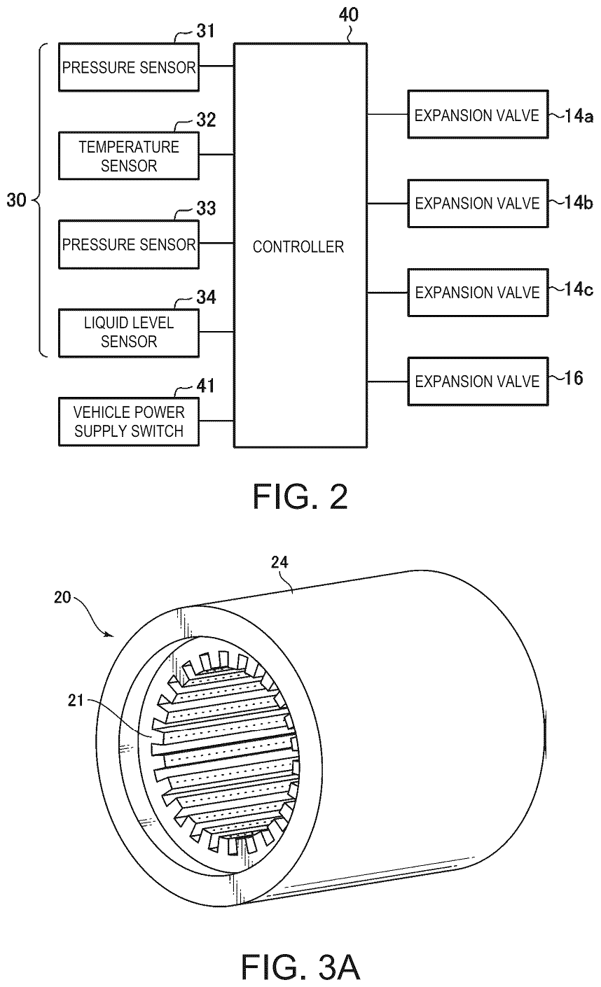

First, the overall configuration of a coolant circulation system according to the present embodiment will be described with reference to FIGS. 1 and 2. FIG. 1 is a schematic configuration diagram of the coolant circulation system according to the present embodiment, and FIG. 2 is an electrical block diagram of the coolant circulation system. A coolant circulation system S shown in FIG. 1 is mounted in a vehicle, such as an electric vehicle, for example, and is configured to cool a motor 20 that is used to drive the vehicle.

The coolant circulation system S forms a refrigeration cycle by using coolant, and includes a coolant circulation circuit 10, a plurality of sensors 30, and a controller 40. The coolant circulation circuit 10 includes, on piping or a channel 3 for a coolant R, a compressor 11, a first heat exchanger 12 serving as a condenser including a capacitor, a fan, and the like, a receiver 13 that receives the coolant R, upstream-side expansion valves 14a, 14b (examples of first expansion valves), an expansion valve 14c (example of a second expansion valve or a bypass expansion valve), second heat exchangers 15a, 15b serving as evaporators, a downstream-side expansion valve 16 (example of a third expansion valve), a gas-liquid separator 17, the motor 20, and an accumulator 18. The coolant R in the present embodiment is a mixture of a natural coolant (for example, CO₂) and lubricating oil.

On the downstream side of the receiver 13, the channel 3 is branched into channels 3a, 3b that communicate with the second heat exchangers 15a, 15b respectively. Coolant from the receiver 13 is supplied to the second heat exchangers 15a, 15b from the upstream-side expansion valves 14a, 14b respectively, through the channels 3a, 3b respectively. The second heat exchangers 15a, 15b are a heat exchanger of an on-vehicle air conditioning apparatus, and a heat exchanger for a lithium battery that supplies electric power to the motor 20, and the like. The channels 3a, 3b merge at a junction C1.

A channel 3c that bypasses the second heat exchangers 15a, 15b is also provided to the channel 3. No heat exchanger is disposed in the channel 3c, so that coolant discharged from the expansion valve 14c is supplied to the downstream side without absorbing heat from a heat exchanger. In the present embodiment, the channel 3c merges with the channel 3 at a junction C2, which is located downstream of the junction C1.

The gas-liquid separator 17 separates liquid from the coolant R flowing through the channel 3 and containing lubricating oil. Although the liquid to be separated is lubricating oil, the liquid may contain coolant R in a liquid phase. The separated liquid is supplied to the accumulator 18 through a separation channel 3d. Accordingly, the gas-liquid separator 17 allows only coolant R in a gas phase to pass therethrough to a portion of the channel 3 located downstream of the gas-liquid separator 17, and only gasified coolant R is used to cool the motor 20. The separated liquid is sent to the accumulator 18, and is mixed with the coolant R (in a gas phase) that is used to cool the motor 20.

The plurality of sensors 30 include a pressure sensor 31, a temperature sensor 32, a liquid level sensor 34, and a pressure sensor 33, the pressure sensor 31 and the temperature sensor 32 being disposed between the junction C2 and the downstream-side expansion valve 16, the liquid level sensor 34 being disposed between the junction C1 and the junction C2, the pressure sensor 33 being disposed between the downstream-side expansion valve 16 and the motor 20. The pressure sensors 31, 33 detect the pressure of the coolant R in the channel 3. The temperature sensor 32 detects the temperature of the coolant R in the channel 3. The liquid level sensor 34 includes a coolant storage chamber 34a and a level meter 34b, the coolant storage chamber 34a being disposed in the channel 3, the level meter 34b detecting the liquid level of the coolant R in the coolant storage chamber 34a. The level meter 34b can continuously measure the level of the liquid surface of the coolant R in the coolant storage chamber 34a. The level meter 34b may be constituted by using a known method, such as a conductivity method, a radio wave method, or a float method.

A pressure sensor or a temperature sensor may be additionally provided in addition to the above-mentioned plurality of sensors. For example, a temperature sensor may be provided between the downstream-side expansion valve 16 and the motor 20, a pressure sensor and a temperature sensor may be additionally provided between the junction C1 and the junction C2 and, further, a pressure sensor and a temperature sensor may be provided in the liquid level sensor 34. The liquid level sensor 34 may be disposed between the junction C2 and the downstream-side expansion valve 16.

The controller 40 is a computing device that includes a processor, a memory, an output/input device, and the like. A predetermined control program, and a database including, for example, information on a pressure-enthalpy chart of the coolant R are stored in the memory. The controller 40 receives detection signals from the plurality of sensors 30, receives a power supply switch signal (on/off signal) from a vehicle power supply switch 41, receives other signals, and based on these signals, controls the upstream-side expansion valves 14a, 14b, 14c, the downstream-side expansion valve 16, and the like by reference to the database.

### Configuration of Motor

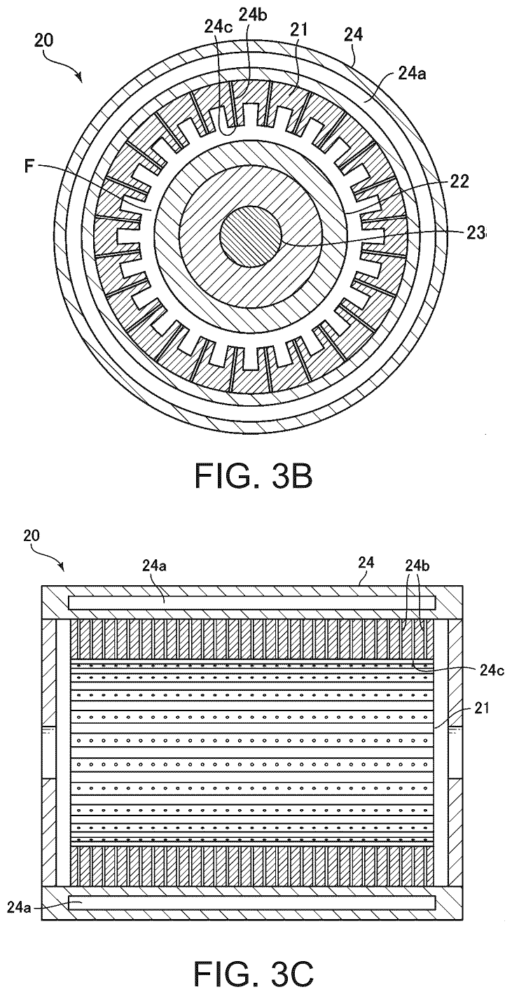

The configuration of the motor 20 according to the present embodiment will be described with reference to FIGS. 3A to 3C. FIG. 3A, FIG. 3B, and FIG. 3C are respectively a perspective view, a transverse cross-sectional view, and a longitudinal cross-sectional view of the motor. To facilitate understanding, some components are omitted in the respective drawings. The motor 20 is an ultra-high speed rotary motor, and is configured to be actuated at a high rotational speed of above 30,000 rpm, for example.

The motor 20 includes a stator 21, a rotor 22, a rotor shaft (rotary shaft) 23, a bearing not shown in the drawings, a housing 24 having a substantially bottomed-cylindrical shape, and the like, a motor coil being wound in the stator 21, permanent magnets being disposed in the rotor 22, the rotor shaft 23 being fixed to the rotor 22, and extending in the axial direction, the housing 24 housing and supporting these components.

A storage passage 24a is formed in a cylindrical part of the housing 24. In addition, capillaries 24b, being a plurality of coolant passages, are formed in the stator 21 in such a manner as to penetrate through respective teeth in the radial direction. To prevent a decrease in electromagnetic performance of the stator 21, each capillary 24b is formed to have an extremely small diameter dimension in cross section. Note that in the present embodiment, each capillary 24b is formed to have a small cross section as described above and hence, liquid phase coolant R induces a high channel resistance, and thus it is difficult to cause the liquid phase coolant R to efficiently pass through the capillaries 24b. Therefore, it is extremely preferable to supply gas phase coolant R to the capillaries 24b. The coolant R supplied to the motor 20 from the channel 3 is supplied to the respective capillaries 24b, and is discharged to a space F between the stator 21 and the rotor 22 from opening parts 24c of the capillaries 24b to cool the motor coil and the like and, thereafter, returns to the channel 3 again, and is sent to the accumulator 18. Note that in the present embodiment, the storage passage 24a of the housing 24 can be used as the coolant storage chamber 34a of the liquid level sensor 34.

### Refrigeration Cycle of Coolant

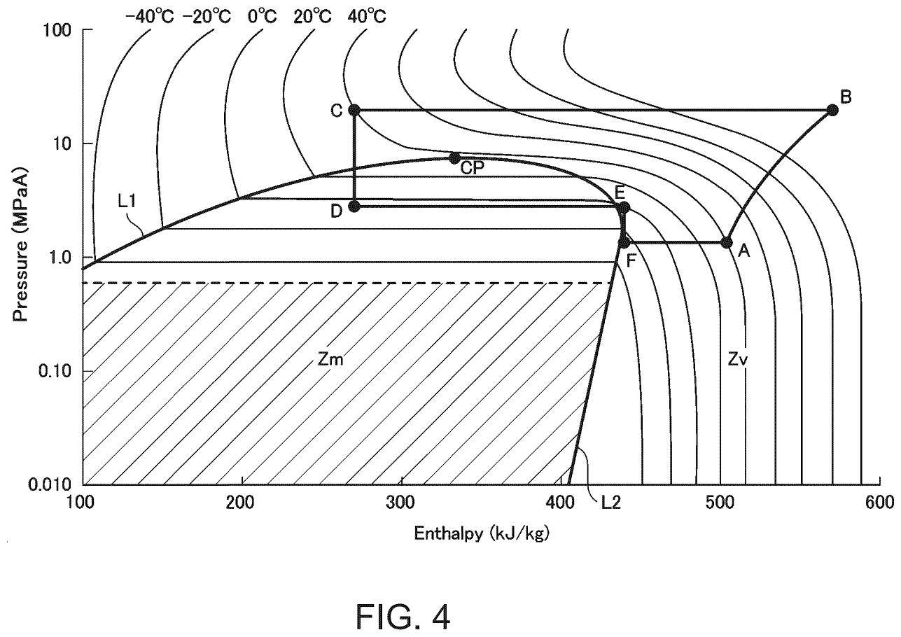

Next, the refrigeration cycle of the coolant R according to the present embodiment will be described with reference to FIG. 4. FIG. 4 shows the refrigeration cycle of the coolant R. The refrigeration cycle is shown on a pressure-enthalpy chart of the coolant R. In FIG. 4, specific enthalpy [KJ/kg] is shown on the horizontal axis, and absolute pressure [MPaA] is shown on the vertical axis. Isotherms are also partially shown in FIG. 4. The critical point of CO₂ coolant at 31° C. is 7.4 MPaA. In a wet vapor region Zm surrounded by a saturated liquid line L1 on the left side of a critical point CP and a saturated vapor line L2 on the right side of the critical point CP, the coolant R is in a gas-liquid mixed phase. Note that in the wet vapor region Zm, the coolant R may sublimate into dry ice at a predetermined pressure (0.52 MPaG) or less. In contrast, in a superheated vapor region Zv on the right side of the saturated vapor line L2, the coolant R is in a gas phase.

First, in the refrigeration cycle (A-B-C-D-E-F) in the present embodiment, a compression stroke (A-B) is performed by the compressor 11. The compressor 11 receives coolant R at high temperature and low pressure (gas) from the accumulator 18 through the channel 3 (point A), compresses the received coolant R, and discharges the coolant R at high temperature and high pressure (supercritical fluid) (point B). Next, a condensation stroke (B-C) is performed by the first heat exchanger 12. The first heat exchanger 12 receives the coolant R at high temperature and high pressure (point B), and causes the coolant R to be condensed and to radiate heat by heat exchange with the external environment (cool air, cooling water, or the like), thus generating the coolant R at intermediate temperature and high pressure (supercritical fluid) (point C).

Next, an expansion stroke (C-D) is performed by the upstream-side expansion valves 14a, 14b. The upstream-side expansion valves 14a, 14b reduce the pressure of the coolant R at intermediate temperature and high pressure to generate the coolant R at low temperature and intermediate pressure (gas-liquid mixture) (point D). Further, an evaporation stroke (D-E) is performed by the second heat exchangers 15a, 15b. The second heat exchangers 15a, 15b perform heat exchange with the coolant R at low temperature and intermediate pressure to cause the coolant R to evaporate and to absorb heat, thus ideally forming the coolant R at low temperature and intermediate pressure (gas) with a superheat degree of zero. Note that the temperatures at the point C and the point D may be changed depending on an outside air temperature or the like.

The present embodiment is characterized by further including a second expansion stroke (E-F), and a second evaporation stroke or a second heat absorption stroke (F-A). In the second expansion stroke (E-F), the downstream-side expansion valve 16 further reduces the pressure of the coolant R at low temperature and intermediate pressure to generate the coolant R at low temperature and low pressure (gas). Lastly, in the second evaporation stroke (F-A), the motor 20 exchanges heat with the coolant R at low temperature and low pressure (gas) and hence, the motor 20 is cooled, and the coolant R at high temperature and low pressure is generated. This coolant R at high temperature and low pressure is returned to the accumulator 18 (point A).

As described above, the refrigeration cycle of the present embodiment has the evaporation stroke (D-E) and the second evaporation stroke (F-A). In the evaporation stroke (D-E), gas-liquid mixed phase coolant R is used in the same manner as a general refrigeration cycle. In contrast, in the second evaporation stroke (F-A), coolant R in a gas phase is used. That is, in the second evaporation stroke (F-A), the coolant R in a gas phase is supplied to the motor 20 to suppress generation of stirring resistance caused by the coolant R in a liquid phase in the space F of the motor 20. In the second evaporation stroke (F-A), the coolant R is supplied to the space F of the motor 20 through the capillaries 24b and, to efficiently supply the coolant R, the coolant R in a gas phase is used.

Note that in the present embodiment, a superheat degree control is performed such that the coolant R is completely gasified (that is, a superheat degree becomes zero or more) in the evaporation stroke (D-E). A superheat degree d is the difference between the temperature T and the saturation temperature Tₛ of the coolant R (d=T−Tₛ). In this superheat degree control, a configuration is adopted in which the controller 40 controls the valve openings of or the flow rates in the upstream-side expansion valves 14a to 14c according to a demand for cooling by the second heat exchangers 15.

Generally, when a cooling demand is low, the controller 40 performs a control such that the flow rates in the upstream-side expansion valves 14a to 14c are reduced to prevent a point E from being present on the left side of the saturated vapor line L2. For example, the controller 40 adjusts the flow rates such that a predetermined target superheat degree (for example, 0 to 1° C.) is maintained at the point E (the junction C2). If the point E is projected to be present on the left side of the saturated vapor line L2 (for example, when a positive liquid level is detected by the liquid level sensor 34, or when the liquid level is rising), the controller 40 can perform a control such that the flow rates in the upstream-side expansion valves 14a to 14c are reduced to move the point E to a position on or to the right of the saturated vapor line L2.

### Summary of Adjustment of Flow Rate Performed by Expansion Valves

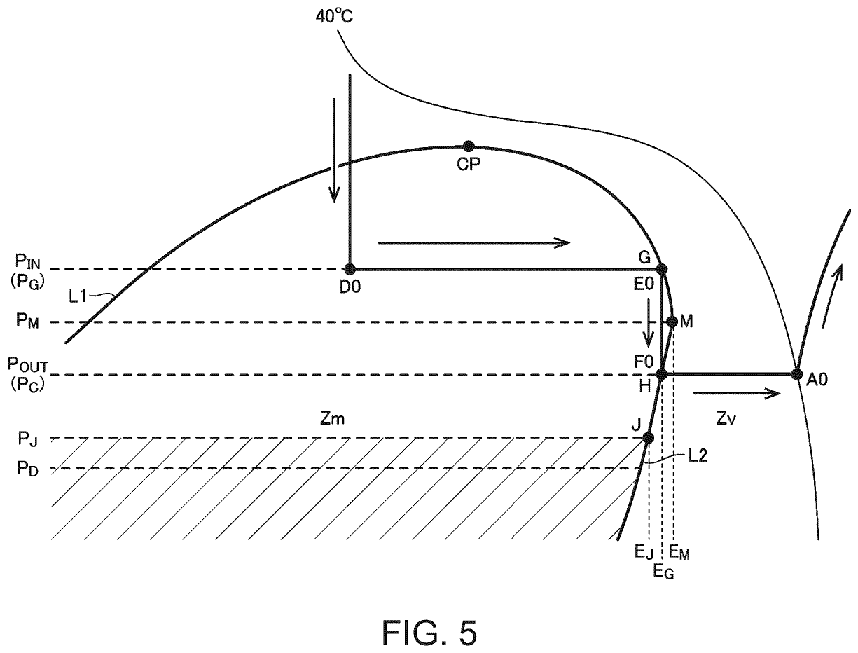

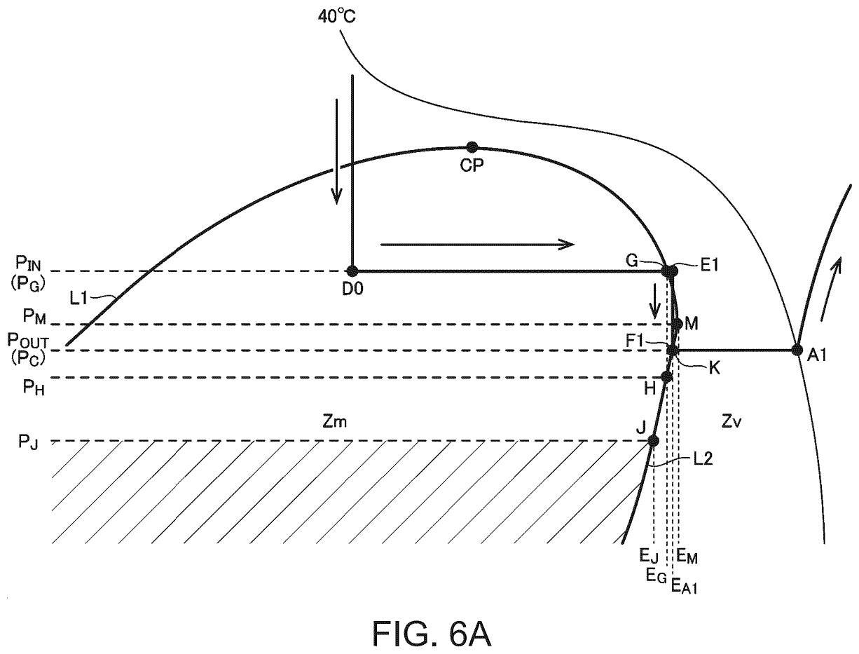

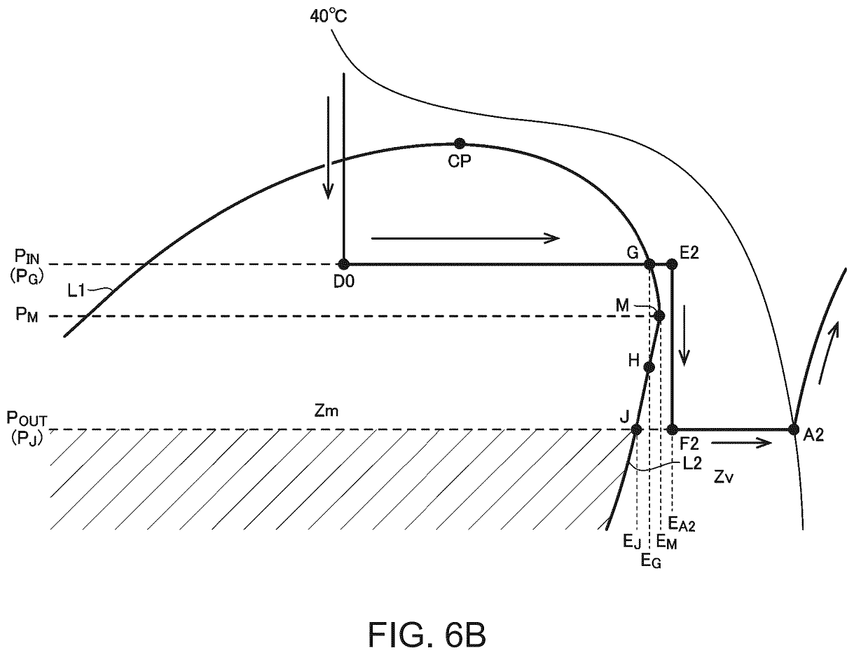

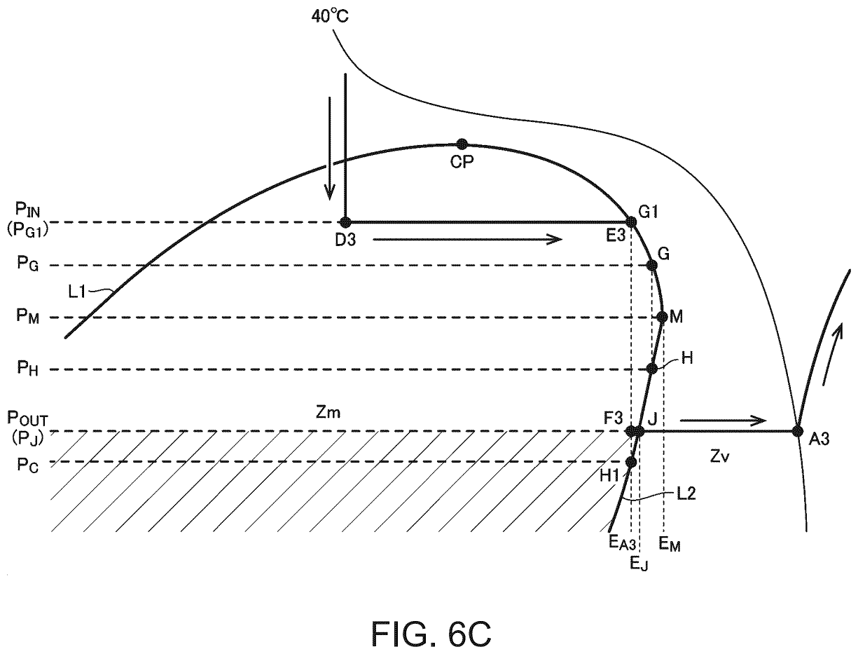

Next, a control of adjusting the flow rate of the coolant R by the upstream-side expansion valves 14a, 14b, 14c, and the downstream-side expansion valve 16 will be described with reference to FIG. 5 to FIG. 6C. FIG. 5 shows a refrigeration cycle in an ideal steady state, and FIGS. 6A to 6C show refrigeration cycles deviating from the refrigeration cycle in the ideal steady state.

Referring to FIG. 5, the saturated vapor line L2 has a local maximum point M where a specific enthalpy E reaches a local maximum with respect to pressure P. At the local maximum point M, the coolant R has a local maximum pressure P_{M} and a local maximum specific enthalpy E_{M}. Two points (a point G and a point H) with the same specific enthalpy may be present on the saturated vapor line L2, on the high pressure side and the low pressure side of the local maximum point M.

The upstream-side expansion valves 14a, 14b, 14c can adjust the flow rate and the pressure, and reduce the pressure of the coolant R to an input pressure P_{IN} (a pressure PG in FIG. 5), which is higher than the local maximum pressure P_{M} (point DO). In the same manner, the downstream-side expansion valve 16 can adjust the flow rate and the pressure, and further reduce the pressure of the coolant R to an output pressure P_{OUT} (a pressure P_{C} in FIG. 5), which is lower than the local maximum pressure P_{M} (point F0). In this Description, coolant R that flows into the downstream-side expansion valve 16 is an example of an “input coolant,” and coolant R outputted from the downstream-side expansion valve 16 is an example of an “output coolant.”

When the flow rate of the coolant R that is reduced in pressure to the input pressure P_{IN} by the upstream-side expansion valves 14a to 14c is balanced with a demand for cooling by the second heat exchangers 15a, 15b, the coolant R at the junction C2 (point E0) is brought into a completely vaporized state with a superheat degree of zero. That is, the point E0 overlaps with the point G on the saturated vapor line L2. The coolant R at the point G has a specific enthalpy E_{G} lower than the local maximum specific enthalpy E_{M} (E_{G}<E_{M}). The corresponding point H is also present on the saturated vapor line L2, a specific enthalpy at the corresponding point H being equal to the specific enthalpy at the point G. A corresponding pressure P_{C} at the corresponding point H is set to a target output pressure P_{T} for the downstream-side expansion valve 16 (P_{T}=P_{C}).

When the downstream-side expansion valve 16 reduces the pressure of the coolant R that flows into the downstream-side expansion valve 16 from the junction C2 to the output pressure P_{OUT} (equal to the corresponding point H, at point F0), the point F0 matches the point H on the saturated vapor line L2 and hence, the coolant R that is reduced in pressure by the downstream-side expansion valve 16 is brought into a gas phase with the superheat degree of zero. The superheat degree of this coolant R is zero and hence, this coolant R provides high cooling capability to the motor 20, so that the specific enthalpy of the coolant R is increased due to heat absorption from the motor 20 (point A0). The point A0 is present on an isotherm of 40° C., for example.

Note that in the wet vapor region Zm, the coolant R may sublimate into dry ice at a predetermined sublimation pressure Pp or less. A point J is set on the saturated vapor line L2, the point J corresponding to a lower limit pressure P_{J} which is higher than this sublimation pressure P_{D} (P_{J}>P_{D}) by an amount corresponding to a predetermined safety margin. The lower limit pressure P_{J} is set to be greater than or equal to the sublimation pressure of lubricating oil contained in the coolant R. In the present embodiment, the lower limit pressure P_{J} is set in advance to a predetermined pressure (for example, 0.6 MPaA). The coolant R at the point J has a lower limit specific enthalpy E_{J}. In the present embodiment, to prevent the coolant R from sublimating into dry ice due to a reduction in pressure performed by the downstream-side expansion valve 16, the output pressure P_{OUT} of the downstream-side expansion valve 16 is limited to a pressure of greater than or equal to the lower limit pressure P_{J}. In FIG. 5, in the wet vapor region Zm, a dry ice region or an inhibition region is set in a region having the lower limit pressure P_{J} or less (hatched area in FIGS. 5 to 6C).

FIG. 6A shows a case in which a demand for cooling by the second heat exchangers 15a, 15b is increased, so that cooling capability of the coolant R supplied from the upstream-side expansion valves 14a to 14c is relatively and slightly reduced. In this case, the coolant R at the junction C2 (example of the input coolant at a point E1) has a specific enthalpy E_{A1}, and has a positive superheat degree. The specific enthalpy E_{A1} is lower than the local maximum specific enthalpy E_{M} (E_{A1}<E_{M}). In this case, a point K is present on the saturated vapor line L2, the specific enthalpy E_{A1} at the point K being equal to the specific enthalpy at the point E1. The point K has the corresponding pressure P_{C} lower than the local maximum pressure P_{M}. In this situation, the corresponding pressure P_{C} at the point K is set to the target output pressure P_{T} for the downstream-side expansion valve 16 (P_{T}=P_{C}).

When the downstream-side expansion valve 16 reduces the pressure of the coolant R (point E1) in such a manner as to cause the output pressure P_{OUT} to match the target output pressure P_{T}, the coolant R flowing into the downstream-side expansion valve 16 from the junction C2 (point F1), the point F1 matches the point K on the saturated vapor line L2 and hence, the coolant R that is reduced in pressure by the downstream-side expansion valve 16 (example of the output coolant at the point F1) is in a gas phase with the superheat degree of zero. The superheat degree of this coolant R is zero and hence, this coolant R provides high cooling capability to the motor 20, and the specific enthalpy of the coolant R is increased due to heat absorption from the motor 20 (point A1).

FIG. 6B shows a case in which a demand for cooling by the second heat exchangers 15a, 15b is further increased, so that cooling capability of the coolant R supplied from the upstream-side expansion valves 14a to 14c is relatively reduced. In this case, the coolant R at the junction C2 (example of the input coolant at a point E2) has a specific enthalpy E_{A2}, and has a positive superheat degree. Further, the specific enthalpy E_{A2} is greater than or equal to the local maximum specific enthalpy E_{M} (E_{A2}≥E_{M}). In this case, a point with the specific enthalpy E_{A2} which is equal to the specific enthalpy at the point E2 is not present on the saturated vapor line L2 (excluding the local maximum point M). In this situation, the lower limit pressure P_{J} at the point J is set to the target output pressure P_{T} for the downstream-side expansion valve 16 (P_{T}=P_{J}).

The downstream-side expansion valve 16 reduces the pressure of the coolant R (point E2) to the lower limit pressure P_{J} in such a manner as to cause the output pressure P_{OUT} to match the target output pressure P_{T}, the coolant R flowing into the downstream-side expansion valve 16 from the junction C2 (point F2). This coolant R (example of the output coolant) is provided to the motor 20, and the specific enthalpy of the coolant R is increased due to heat absorption from the motor 20 (point A2). The lower limit pressure P_{J} is the lowest pressure in a pressure control range for the output pressure P_{OUT} of the downstream-side expansion valve 16 and, at this lower limit pressure P_{J}, it is possible to ensure a difference in specific enthalpy between the point F2 and the point A2 (isotherm of 40° C.) (that is, cooling capability) to be greater than in the case in which a pressure higher than the lower limit pressure P_{J} is set to the target output pressure P_{T} in the situation in FIG. 6B.

FIG. 6C shows a case in which the input pressure P_{IN} (P_{IN}=P_{G1}) brought about by the upstream-side expansion valves 14a to 14c is higher than a pressure PG in a steady state. In this case, the coolant R at the junction C2 (example of the input coolant at a point E3) has a specific enthalpy E_{A3}, and the superheat degree of the coolant R at the junction C2 is zero. The point E3 overlaps with a point G1 on the saturated vapor line L2. The specific enthalpy E_{A3} is lower than the local maximum specific enthalpy E_{M} (EA3<E_{M}). In this case, a corresponding point H1 is present on the saturated vapor line L2, the specific enthalpy E_{A3} at the corresponding point H1 being equal to the specific enthalpy at the point E3. In the example shown in FIG. 6C, the corresponding point H1 has the corresponding pressure P_{C} lower than the lower limit pressure P_{J}. The specific enthalpy E_{A3} at the corresponding point H1 is lower than the lower limit specific enthalpy E_{J}. In this situation, the lower limit pressure P_{J}, which is the lowest pressure in the pressure control range, is set to the target output pressure P_{T} for the downstream-side expansion valve 16 (P_{T}=P_{J}).

The downstream-side expansion valve 16 reduces the pressure of the coolant R (point E3) to the lower limit pressure P_{J} in such a manner as to cause the output pressure P_{OUT} to match the target output pressure P_{T}, the coolant R flowing into the downstream-side expansion valve 16 from the junction C2 (point F3). The point F3 is located slightly to the left side of the saturated vapor line L2, and is in the wet vapor region Zm and hence, the coolant R (example of the output coolant) that is reduced in pressure by the downstream-side expansion valve 16 is in a gas-liquid mixed phase in which the coolant R contains a liquid phase coolant, although the proportion of the liquid phase coolant is small. When this coolant R passes through the gas-liquid separator 17, the liquid phase coolant R, which is present in a small proportion, is recovered from the gas-liquid mixed phase coolant R, and a large portion of a gas phase coolant R is supplied to the motor 20. In this case, it is possible to provide high cooling capability to the motor 20 by the gas phase coolant R. The specific enthalpy of the gas phase coolant R is increased due to heat absorption from the motor 20 (point A2).

### Process Flow

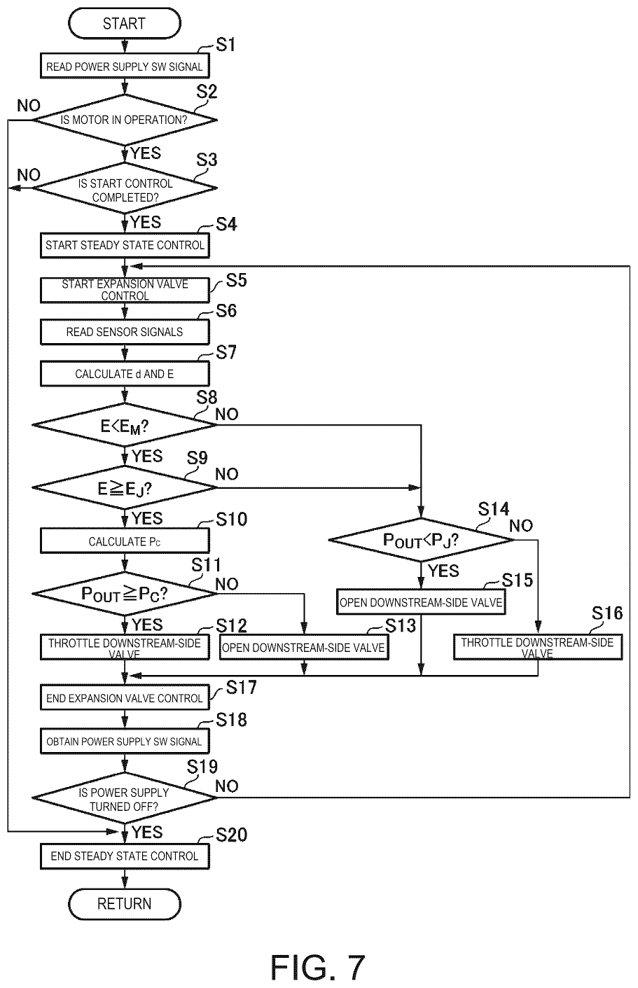

Next, a process flow of the coolant circulation system S of the present embodiment will be described with reference to FIG. 7. When the process is started, the controller 40 reads a vehicle power supply switch signal from the vehicle power supply switch 41 (S1) and, based on the vehicle power supply switch signal, the controller 40 determines whether the vehicle power supply is turned on, so that the motor 20 of the vehicle is in operation (S2). When a negative determination is made (S2; NO), although the process is ended, the controller 40 repeatedly performs the process shown in FIG. 7 for every predetermined time. In contrast, when an affirmative determination is made (S2; YES), the controller 40 determines based on a predetermined signal input whether a start control for the vehicle is completed (S3) and, after the start control is completed (S3; YES), the controller 40 starts a steady state control for the refrigeration cycle (S4). The steady state control is repeatedly performed until it is determined based on a vehicle power supply switch signal that the vehicle power supply is turned off (S18 to S20).

When the steady state control is started, the controller 40 starts an expansion valve control (S5), and reads detection signals from the plurality of sensors 30 (S6). Based on the detection signals, the controller 40 estimates the superheat degree d and the specific enthalpy E of the coolant R at an intermediate position (corresponding to the junction C2) between the downstream-side expansion valve 16 and the second heat exchangers 15a, 15b (S7). Therefore, first, based on the detection signals from the pressure sensor 31 and the temperature sensor 32, the controller 40 obtains the input pressure P_{IN} and the temperature T of the coolant R to be supplied to the downstream-side expansion valve 16, and estimates the superheat degree d and the specific enthalpy E of the coolant R from the input pressure P_{IN} and the temperature T of the coolant R by reference to information on the pressure-enthalpy chart of the coolant R.

The controller 40 can calculate the superheat degree d by subtracting the saturation temperature Tₛ at the input pressure P_{IN} from the temperature T of the coolant R (d=T−Tₛ≥0). The controller 40 can estimate the specific enthalpy E based on the temperature T (T≥Tₛ) by reference to the information on the pressure-enthalpy chart of the coolant R.

Note that in the wet vapor region Zm, even when the specific enthalpy of the coolant R is changed, the temperature T of the coolant R remains the same as the saturation temperature Tₛ until the coolant R is completely gasified. However, in the present embodiment, as described above, by performing the superheat degree control, flow rates in the upstream-side expansion valves 14a to 14c are controlled to prevent the coolant R at the intermediate position from being in the wet vapor region Zm. Accordingly, in the present embodiment, it is assumed that, in the process flow shown in FIG. 7, the coolant R at the intermediate position is completely gasified, and is in the superheated vapor region Zv. In the superheated vapor region Zv, the temperature T of the coolant R increases with an increase in specific enthalpy.

Next, the controller 40 determines whether the estimated specific enthalpy E is lower than the local maximum specific enthalpy E_{M} at the local maximum point M (S8), and whether the estimated specific enthalpy E is greater than or equal to the lower limit specific enthalpy E_{J} at the lower limit pressure P_{J} (S9). The local maximum specific enthalpy E_{M} at the local maximum point M and the lower limit specific enthalpy E_{J} at the lower limit pressure P_{J} are values known from the pressure-enthalpy chart, and the controller 40 can read these values from the database. When an affirmative determination is made for each step (S8 and S9; YES. Corresponding to the situation in FIG. 5 or FIG. 6A), the controller 40 calculates the corresponding pressure P_{C} at a point on the saturated vapor line L2, which is lower than the local maximum pressure P_{M} and has a specific enthalpy equal to the specific enthalpy E (see FIG. 5, FIG. 6A, or FIG. 6C) (S10). The controller 40 sets the corresponding pressure P_{C} to the target output pressure P_{T} for the downstream-side expansion valve 16 (P_{T}=P_{C}).

Next, based on the detection signals from the plurality of sensors 30 (the pressure sensor 33), the controller 40 obtains the output pressure P_{OUT} of the coolant R supplied by the downstream-side expansion valve 16, and controls the downstream-side expansion valve 16 in such a manner as to cause the output pressure P_{OUT} to match the target output pressure P_{T} (P_{C}) and, thereafter, the controller 40 shifts to step S20. That is, when the output pressure P_{OUT} is greater than or equal to the target output pressure P_{T} (P_{C}) (S11; YES), the controller 40 reduces the flow rate by reducing the valve opening of the downstream-side expansion valve 16 by a predetermined valve opening, whereas when the output pressure P_{OUT} is lower than the target output pressure P_{T} (P_{C}) (S11; NO), the controller 40 increases the flow rate by increasing the valve opening of the downstream-side expansion valve 16 by a predetermined valve opening. Consequently, at the time of the flow rate reduced, the output pressure P_{OUT} of the coolant R in the channel 3 from the downstream-side expansion valve 16 to the motor 20 is reduced, whereas when the flow rate is increased, the output pressure P_{OUT} is elevated. In both cases, the output pressure P_{OUT} is changed toward the target output pressure P_{T} (P_{C}).

In contrast, when a negative determination is made in step S8 (S8; NO. Corresponding to the situation in FIG. 6B), or when a negative determination is made in step S9 (S9; NO. Corresponding to the situation in FIG. 6C), the controller 40 sets the lower limit pressure P_{J} to the target output pressure P_{T} for the downstream-side expansion valve 16 (P_{T}=P_{J}), obtains the output pressure P_{OUT} of the downstream-side expansion valve 16 based on the detection signals from the plurality of sensors 30 (the pressure sensor 33), and controls the downstream-side expansion valve 16 in such a manner as to cause the output pressure P_{OUT} to match the target output pressure P_{T} (P_{J}) and, thereafter, the controller 40 shifts to step S20.

That is, when the output pressure P_{OUT} is lower than the target output pressure P_{T} (P_{J}) (S14; YES), the controller 40 increases the flow rate by increasing the valve opening of the downstream-side expansion valve 16 by a predetermined valve opening, whereas when the output pressure P_{OUT} is greater than or equal to the target output pressure P_{T} (P_{J}) (S14; NO), the controller 40 reduces the flow rate by reducing the valve opening of the downstream-side expansion valve 16 by a predetermined valve opening. Consequently, when the flow rate is increased, the output pressure P_{OUT} of the coolant R in the channel 3 from the downstream-side expansion valve 16 to the motor 20 is elevated, whereas when the flow rate is reduced, the output pressure P_{OUT} is reduced. In both cases, the output pressure P_{OUT} is changed toward the target output pressure P_{T} (P_{J}).

### Manner of Operation and Advantageous Effects

Next, the manner of operation and advantageous effects of the coolant circulation system S according to the present embodiment will be described.

The coolant circulation system S according to the present embodiment is the coolant circulation system S that circulates a CO₂ coolant R to cool the motor 20 in a vehicle, the coolant circulation system S including: the coolant circulation circuit 10 that forms the refrigeration cycle including, in the channel 10 through which the coolant R is circulated, the compressor 11, the first heat exchanger 12, the upstream-side expansion valves 14a to 14c, the second heat exchangers 15a, 15b, the downstream-side expansion valve 16, and the motor 20; the compressor 11 compressing the coolant R; the first heat exchanger 12 causing the coolant R; which is compressed, to radiate heat; the upstream-side expansion valves 14a to 14c causing the coolant R, which is caused to radiate heat, to expand; the second heat exchangers 15a, 15b causing the coolant R, which is expanded by the upstream-side expansion valves 14a to 14c, to absorb heat; the downstream-side expansion valve 16 causing the coolant R that flows out from the second heat exchangers 15a, 15b to expand; the motor 20 causing the coolant R, which is expanded by the downstream-side expansion valve 16, to absorb heat; the first sensors (the pressure sensor 31, the temperature sensor 32) that detect at least the pressure P and the temperature T of the input coolant, being the coolant R to be supplied to the downstream-side expansion valve 16; the second sensor (the pressure sensor 33) that detects at least the pressure P of the output coolant, being the coolant R discharged from the downstream-side expansion valve 16; and the controller 40 that performs a control such that the input coolant having the input pressure P_{IN} and being in a gas phase is outputted by the upstream-side expansion valves 14a to 14c, the pressure of the input coolant is reduced by the downstream-side expansion valve 16, and the output coolant having the output pressure P_{OUT} is outputted from the downstream-side expansion valve 16. The input pressure P_{IN} is set to a pressure higher than the local maximum pressure P_{M} at the local maximum point M, at which the specific enthalpy E reaches the local maximum, on the saturated vapor line L2 of the pressure-enthalpy chart of the coolant R, and the controller 40 estimates the corresponding pressure P_{C} of the coolant R at the corresponding point H on the saturated vapor line L2, a specific enthalpy at the corresponding point H being equal to the specific enthalpy of the input coolant, the corresponding point H being located on the low pressure side of the local maximum pressure P_{M} (S10), sets the corresponding pressure P_{C} to the target output pressure P_{T}, and controls the downstream-side expansion valve 16 based on the detection signal from the second sensor (the pressure sensor 33) such that the output pressure P_{OUT} of the downstream-side expansion valve 16 reaches the target output pressure P_{T} (S11 to S13).

In the present embodiment having such a configuration, the motor 20 is incorporated in the refrigeration cycle, as a heat source that elevates the specific enthalpy of the coolant R, in addition to the second heat exchangers 15a, 15b. That is, the present embodiment has a configuration in which although a gas-liquid mixed phase coolant R is supplied to the second heat exchangers 15a, 15b in the same manner as the ordinary refrigeration cycle, the coolant R that absorbs heat from the second heat exchangers 15a, 15b further cools the motor 20. At this point of operation, in the present embodiment, the corresponding pressure P_{C} of the coolant R at the corresponding point H on the saturated vapor line L2 is estimated, a specific enthalpy at the corresponding point H being equal to the specific enthalpy of the coolant R that absorbs heat from the second heat exchangers 15a, 15b, thus being in a gas phase (example of the input coolant), the corresponding point H being located on the low pressure side of the local maximum pressure P_{M}, and this corresponding pressure P_{C} is set to the target output pressure P_{T} for the downstream-side expansion valve 16. Consequently, in the present embodiment, it is possible to supply the output coolant in a gas phase from the downstream-side expansion valve 16 to the motor 20, the output coolant having sufficient cooling capability with a superheat degree of zero.

According to the present embodiment, based on the detection signals from the first sensors (the pressure sensor 31, the temperature sensor 32), the controller 40 controls the flow rates in the upstream-side expansion valves 14a to 14c such that the specific enthalpy E of the input coolant is lower than the local maximum specific enthalpy E_{M} at the local maximum point M. In the present embodiment having such a configuration, it is possible to supply the input coolant with a low superheat degree to the downstream-side expansion valve 16.

According to the present embodiment, the controller 40 sets the target output pressure P_{T} to the predetermined set pressure (for example, the lower limit pressure P_{J}) when the controller 40 determines based on the detection signals from the first sensors (the pressure sensor 31, the temperature sensor 32) that the specific enthalpy E of the input coolant is greater than or equal to the local maximum specific enthalpy E_{M} at the local maximum point M (S8; NO). In the present embodiment having such a configuration, when the superheat degree of the input coolant is high, so that the corresponding point H is not present, by setting the target output pressure P_{T} to the predetermined set pressure (the lower limit pressure P_{J}), cooling capability of the output coolant can be ensured.

According to the present embodiment, the controller 40 sets the target output pressure P_{T} to the predetermined lower limit pressure P_{J} instead of the corresponding pressure P_{C} when the specific enthalpy (E_{A3}) at the corresponding point H is less than the predetermined lower limit specific enthalpy E_{J} (S9; NO), and the lower limit pressure P_{J} is a pressure higher than the sublimation pressure P_{D} in the wet vapor region Zm of the pressure-enthalpy chart, the sublimation pressure P_{D} being a pressure at which dry ice can be present. In the present embodiment having such a configuration, when the corresponding point H is present and there is a risk of the coolant R at the corresponding point H sublimating into dry ice, by setting the target output pressure P_{T} to the predetermined lower limit pressure P_{J}, it is possible to prevent the output coolant from containing a coolant in a solid phase.

According to the present embodiment, the coolant circulation circuit 10 further includes the gas-liquid separator 17 in the channel 3 at a position between the downstream-side expansion valve 16 and the motor 20, and the coolant R from which liquid is separated by the gas-liquid separator 17 is supplied to the motor 20. In the present embodiment having such a configuration, when the output coolant is in a gas-liquid mixed phase (for example, the target output pressure P_{T} is not at the corresponding pressure P_{C}, but is at the lower limit pressure P_{J}), by recovering the liquid from the output coolant by the gas-liquid separator 17, it is possible to supply only a coolant in a gas phase to the motor 20.

According to the present embodiment, the coolant passages (the capillaries 24b) are formed in the motor 20 in such a manner as to supply the coolant R to the space F between the stator 21 and the rotor 22 of the motor 20. In the present embodiment having such a configuration, a gas phase coolant R is supplied to the space F in the motor 20 and hence, it is possible to suppress an increase in stirring resistance when the motor 20 is in operation.

According to the present embodiment, the second heat exchangers 15a, 15b include a heat exchanger of an on-vehicle air conditioning apparatus and/or a heat exchanger for a vehicle battery. In the present embodiment having such a configuration, it is possible to incorporate an ordinary heat exchanger for the vehicle in the coolant circulation system S.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

Further, if used herein, a phrase of the form “at least one of A and B” means at least one A or at least one B, without being mutually exclusive of each other, and does not require at least one A and at least one B. If used herein, the phrase “and/or” means either or both of two stated possibilities.

### REFERENCE CHARACTER LIST

3, 3a to 3c channel
10 coolant circulation circuit
11 compressor
12 first heat exchanger
14a, 14b, 14c upstream-side expansion valve
15a, 15b second heat exchanger
16 downstream-side expansion valve
17 gas-liquid separator
20 motor
21 stator
22 rotor
24 housing
24b capillary
31,33 pressure sensor
32 temperature sensor
34 liquid level sensor
40 controller
F space
R coolant
S coolant circulation system

1. A coolant circulation system that circulates a CO₂ coolant to cool a motor in a vehicle, the coolant circulation system comprising:
a coolant circulation circuit that forms a refrigeration cycle including, in a channel through which the coolant is circulated, a compressor, a first heat exchanger, an upstream-side expansion valve, a second heat exchanger, a downstream-side expansion valve, and the motor; the compressor compressing the coolant; the first heat exchanger causing the coolant, which is compressed, to radiate heat; the upstream-side expansion valve causing the coolant, which is caused to radiate heat, to expand; the second heat exchanger causing the coolant, which is expanded by the upstream-side expansion valve, to absorb heat; the downstream-side expansion valve causing the coolant that flows out from the second heat exchanger to expand; the motor causing the coolant, which is expanded by the downstream-side expansion valve, to absorb heat;
first sensors that detect at least a pressure and a temperature of an input coolant, the input coolant being the coolant to be supplied to the downstream-side expansion valve;
a second sensor that detects at least a pressure of an output coolant, the output coolant being the coolant discharged from the downstream-side expansion valve; and
a controller that performs a control such that the input coolant having an input pressure and being in a gas phase is outputted from the upstream-side expansion valve, the pressure of the input coolant is reduced by the downstream-side expansion valve, and the output coolant having an output pressure is outputted from the downstream-side expansion valve, wherein
the input pressure is set to a pressure higher than a local maximum pressure at a local maximum point, at which a specific enthalpy reaches a local maximum, on a saturated vapor line of a pressure-enthalpy chart of the coolant; and
the controller:
estimates a corresponding pressure of the coolant at a corresponding point on the saturated vapor line, a specific enthalpy at the corresponding point being equal to a specific enthalpy of the input coolant, the corresponding point being located on a low pressure side of the local maximum pressure;
sets the corresponding pressure to a target output pressure; and
controls the downstream-side expansion valve based on a detection signal from the second sensor such that the output pressure of the downstream-side expansion valve reaches the target output pressure.

2. The coolant circulation system according to claim 1, wherein, based on detection signals from the first sensors, the controller controls a flow rate in the upstream-side expansion valve such that the specific enthalpy of the input coolant is lower than the specific enthalpy at the local maximum point.

3. The coolant circulation system according to claim 1, wherein the controller sets the target output pressure to a predetermined set pressure when the controller determines, based on detection signals from the first sensors, that the specific enthalpy of the input coolant is greater than or equal to the specific enthalpy at the local maximum point.

4. The coolant circulation system according to claim 1, wherein the controller sets the target output pressure to a predetermined lower limit pressure instead of the corresponding pressure when the specific enthalpy at the corresponding point is less than a predetermined lower limit specific enthalpy; and
the lower limit pressure is a pressure higher than a sublimation pressure in a wet vapor region of the pressure-enthalpy chart, the sublimation pressure being a pressure at which dry ice can be present.

5. The coolant circulation system according to claim 1, wherein the coolant circulation circuit further includes a gas-liquid separator in the channel at a position between the downstream-side expansion valve and the motor, and the coolant from which liquid is separated by the gas-liquid separator is supplied to the motor.

6. The coolant circulation system according to claim 1, wherein a coolant passage is formed in the motor in such a manner as to supply the coolant to a space between a stator and a rotor of the motor.

7. The coolant circulation system according to claim 1, wherein the second heat exchanger includes a heat exchanger of an on-vehicle air conditioning apparatus and/or a heat exchanger for a vehicle battery.
